(19) United States
(12) Patent Application Publication
(10) Pub. No.: US 2002/0157273 A1
(43) Pub. Date: Oct. 31, 2002

(54) Device and method for fitting a waistband

(76) Inventor: Lily Noyes, Richfield, MN (US)

Correspondence Address: Thomas P. Liniak, Esq., Liniak, Berenato, Longacre & White, LLC, 6550 Rock Spring Drive, Suite 240, Bethesda, MD, 20817, US

(21) Appl. No.: 09/840,900

(22) Filed: Apr. 25, 2001

(51) Int. Cl. G01B 3/10

(52) U.S. Cl. 33/759; 33/758; 33/512

(57) ABSTRACT

A device and method for fitting a waistband is provided that is infinitely adjustable. The device permits the fitting of a waistband of an article of clothing to a very precise measurement without necessitating the ultimate wearer of the garment to have to try the article of clothing on.

### FIELD OF INVENTION

This invention relates to a device for fitting a waistband for an article of clothing. More particularly, this invention relates to a device for fitting the waistband for an article of clothing such as a skirt, dress or slacks on the device without necessitating trying the garment on the ultimate wearer of the clothing.

### BACKGROUND OF THE INVENTION

The problem of fitting an article of clothing to the particular size of a wearer has been around for centuries. Many attempts have been made to provide tools for tailors, seamstresses, and the like to attempt to precisely measure and therefore fit articles of clothing to the particular dimensions and tastes of wearers. Only a limited number of these devices have related in any way to waistband. An even smaller number have related to fitting of a waistband but those have necessitated trying the garment on the ultimate wearer of the clothing.

For example, U.S. Pat. No. 124,602 discloses a tailor scale having a plurality of different measures on the same device that apply to different articles of clothing. This device, however, is strictly for measurement only and not for fitting of waistlines of other items.

Similarly, U.S. Pat. No. 667,739 discloses a dressmaker's rule that is composed of a single unjointed strip of rigid or flexible material. This device, again, is for measurement only and is restricted to a two-foot length.

U.S. Pat. No. No. 673,782 discloses an apparatus for marking and trimming the lower edges of skirts. This device, however, with its platform is strictly intended for measuring hems only and can not be used to measure or fit waistlines.

U.S. Pat. No. 800,696 discloses a collar measurer and fitter. The device comprise of a metal plate with a plurality of slots which are spaced in inch increments to measure, fit and finish collars, stocks or ribbons for the neck of a wearer. This device does not measure or fit waistbands. The device is further provided with rows of holes which are designed to be utilized while embroidering a collar which is previously fitted onto the plate. The holes may be utilized for basting the collar in position. The device disclosed in the '696 patent does not permit infinite adjustability of the collar dimension. It, likewise, does not permit the collar to be selectively attached along the entire length of the measurer and fitter. Additionally, the smooth surface of the device encourages any fabric against it to slide rather than retaining it in a given position.

U.S. Pat. No. 910,508 discloses a device for fitting and turning the skirts and coats. The device provides a platform for the person being fitted to stand on and, therefore, only provides the ability to measure and fit the bottom of a skirt or a coat and not to measure or fit the waistline of a garment.

U.S. Pat. No. 2,780,003 discloses individual dress patterns and forms. These patterns and forms are required to be fitted over the actual wearer and they are then placed over a dress form in order to replicate the particular shape of the individual that the clothing is made for. This pattern and form replicates the entire garment and further requires the use of a mannequin or form in order to make a garment which presents storage problems.

U.S. Pat. No. 3,401,459 to Gamore discloses a pattern layout guide or instrument. The guide has longitudinal markings corresponding to available or standard widths of material. A pattern is laid on the device and then measured. This device permits one to determine how much material is needed for a pattern but does not enable one to fit a waistline.

None of the patents discussed above recognize or address to the problems found to exist with respect to attempting to fit a waistband for an article of clothing such as a skirt, dress or slacks, without requiring the garment to be tried on or the use of a mannequin or dress form. It has been found that in fitting a waistband, it would be helpful if it could be precisely constructed to the very particular measurements of a wearer without requiring the wearer to try the garment on. It has also been found that it would be helpful to have a device that fits a waistband that can be virtually infinitely adjustable to very precisely replicate the waist size of the wearer.

In view of the above, it is apparent that there exists a need in the art for an improved device for fitting the waistband of an article of clothing that does not require the garment to be tried on for the waistband to be fit.

It is a purpose of this invention to fulfill the above-described needs in the art, as well as other needs apparent to the skilled artists and from the following detailed description of this invention.

### SUMMARY OF THE INVENTION

Generally speaking, this invention fulfills the above-described needs in the art by providing a device for fitting a waistband comprising:

a flexible main body having an inner and outer surface, first and second ends and a measuring scale above a portion of its length, said main body being selectively movable from a first open position to a second closed loop position wherein said first end and said second end overlap and the size of the circumference of said loop is visible on said scale at the point at which said first end overlaps said scale;

adjustable means for releaseably retaining said body in a preselected closed position that corresponds to a desired waistband size; and

means for releaseably attaching said waistband to said body located on said body below said measuring scale.

According to certain preferred embodiments, the device for fitting a waistband that is infinitely adjustable, has a void free surface and is storable in a flat position.

According to further preferred embodiments, the device for fitting a waistband has a roughened surface that contacts the waistband to be fitted.

This invention still further fulfills the above-described needs in the art by providing a method of fitting a waistband comprising the steps of:

providing a flexible main body having an inner and outer surface, first and second ends and a measuring scale along a portion of its length;

overlapping said first and second ends to form a closed loop wherein the size of the circumference of said loop is visible on said scale at the point at which said first end overlaps said scale;

releaseably retaining said body in a preselected closed loop position that corresponds to a desired waistband size without trying on the main body on the ultimate wearer of the waistband; and

releaseably attaching a waistband to said body below said measuring scale.

### BRIEF DESCRIPTION OF THE DRAWINGS

FIG. 1 is a front view of the fitting device according to an embodiment of this invention.

FIG. 2 is a rear view of the fitting device according to an embodiment of this invention.

FIG. 3 is a cross-sectional view taken along the line 3.3 in FIG. 2.

FIG. 4 is a perspective view of the fitting device according to the embodiment of this invention.

FIG. 5 is a perspective view of a fitting device according to an embodiment of this invention illustrated in a closed position.

### DETAILED DESCRIPTION OF CERTAIN EMBODIMENTS OF THIS INVENTION

This invention will now be described with reference to the following FIGS. in which like reference numerals indicate like parts throughout the several views.

It will be appreciated by those of skill in the art that the waistband-fitting device and method according to this invention may be used in conjunction with a wide variety of pieces of clothing (e.g., dresses, slacks, skirts, etc.). However, the invention is described below in a preferred embodiment which is used in conjunction with the fitting of a waistband for a skirt.

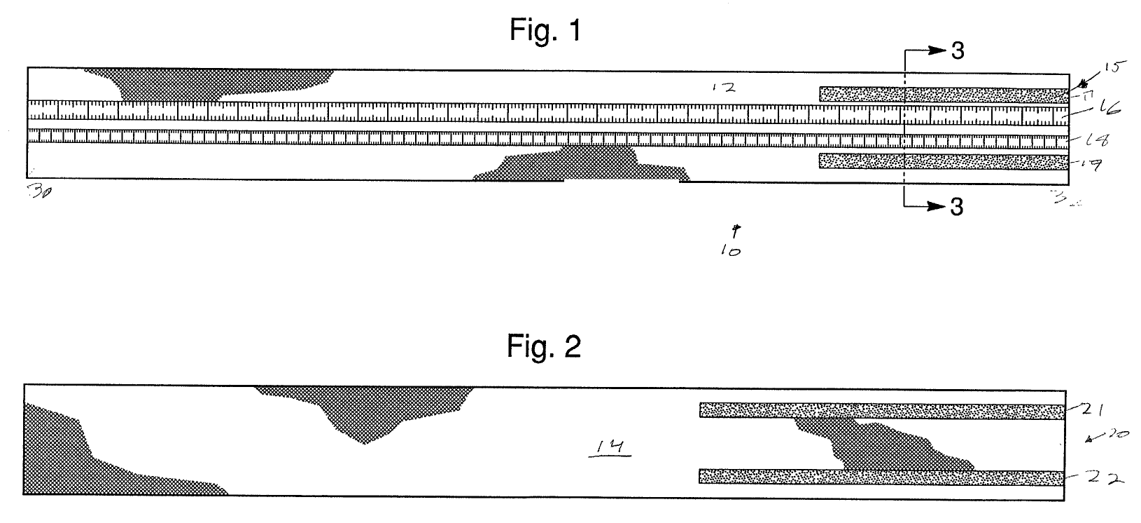

FIG. 1 is a top view of the device 10 illustrating its outer surface 12 and the features thereof. The surface 12 contains at least one measuring device such as a scale 16 extending along all or a substantial portion of its entire length. In preferred embodiments, the device 10 may contain more than one measuring device such as scales 16 and 18 in FIG. 1 so that measurements may be selectively made in either metric or standard United States units. Both units could also be provided on a single scale. The measuring scales 16 and 18 may be separate measuring tapes or similar devices that are adhered or affixed removably or permanently to the surface 12. In the alternative, one or more measuring devices such as scales 16 and 18 may be formed or printed directly on or in the surface 12 of the device 10.

The device 10 is preferably constructed in a manner such that it can form a closed loop in order to replicate the waistband of an article of clothing of a wearer. In particularly preferred embodiments of the invention, the device 10 is selectively movable from a first closed loop position to a second open position where it can be laid flat for ease of storage or transport. In order to accomplish this, the outer surface 12 can be provided with at least one portion of a fastening system 15 that permits the leading end 30 of the device 10 to overlap the trailing end 32 and to allow the device 10 to form a closed loop as illustrated in FIG. 5. Fastening system 15 takes the form of one element of a hook and loop fastening system with two different fastening surfaces 17 and 19 respectively. It will be appreciated by those of skill in the art that alternative fastening systems can be utilized such as adhesive strips or other similar systems that permit the device 10 to form a loop where the end 30 overlaps the end 32 and releaseably retains the device in this configuration. It is likewise preferred that the fastening system 15 permit infinite adjustability of the loop formed by overlapping the ends 30 and 32 and that the system 15 permit a user to form the device 10 into a loop configuration and selectively release it over preferably thousands of cycles without a significant degradation of the retaining ability of the fastening system 15.

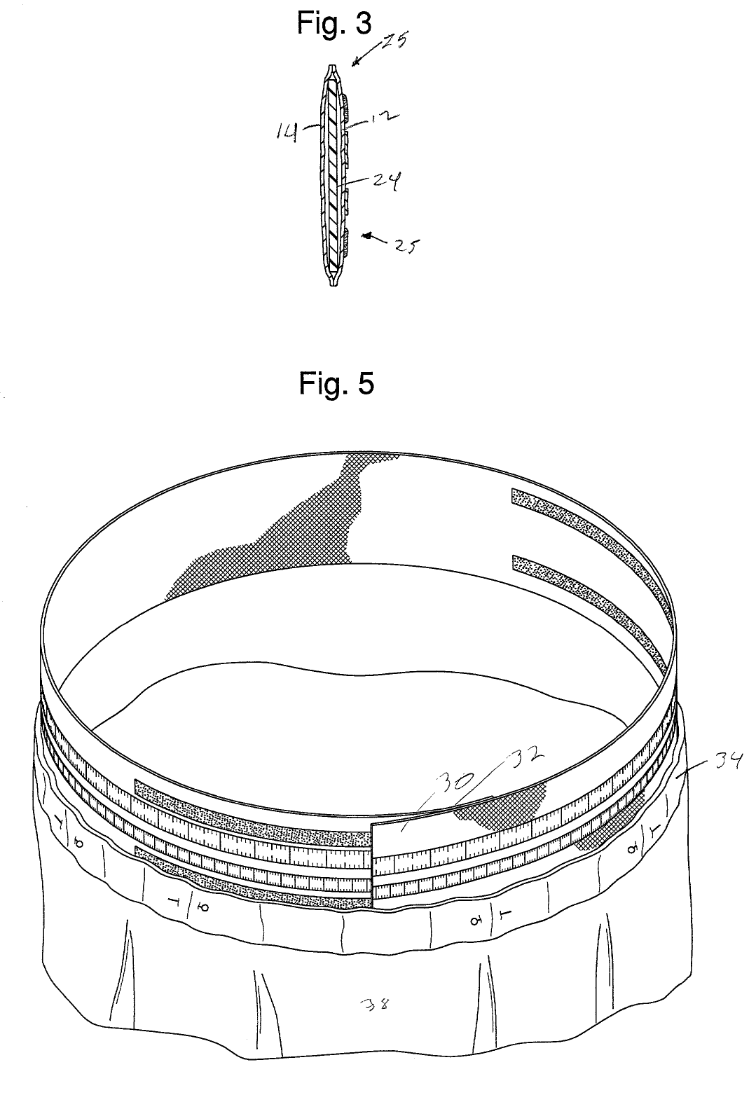

The device 10 must also have sufficient flexibility to allow it to form the closed loop configuration illustrated in FIG. 5. At the same time, it must have sufficient rigidity to stand on its own and permit a waistband to be pinned or otherwise attached thereto. A variety of different materials can be utilized to achieve these purposes. For example, the device could be constructed of a plastic, rubber, cardboard or cloth material. Alternatively, as illustrated in FIG. 3, the device could be constructed with an inner flexible member 24 made of rubber, plastic or the like which is then partially or completely contained within an outer covering 25. The covering 25 can be formed by joining the outer and inner surfaces 12 and 14 respectively of the device 10 or other known techniques.

As illustrated in FIG. 5, when in use the device 10 permits the fitting of a waistband of a skirt or the like to a very precise measurement without necessitating the ultimate wearer of the garment to have to try the article of clothing on. For this reason, it is preferable that at least a portion of the outer surface 12 that is in contact with the waistband 34 be provided with a rough surface of fabric or other material in the area where the waistband will contact the device 10. This rough surface is preferable so that the garment 38 that is being fitted is not permitted to freely slide along the surface 12.

Additionally, the portion of the device 10 that contacts the waistband 34 that is to be fitted further must be constructed of a material that allows the waistband 34 to be pinned to it. A further consideration is that the material of the device should be capable of withstanding thousands of temporary pinholes through the life of the device without degradation of the surface 12 or the device 10. A particular useful covering for all or a portion of the outer surface 12 and, in some instances, a similar region of inner surface has been found to be burlap. This material is sufficiently rough to resist sliding of the garment against the device 10 and also facilitates the pinning of a waistband to it.

FIG. 2 illustrates the inner surface 14 of the device 10. In accordance with a preferred embodiment, the surface 14 is provided with a fastening system 20 that is comprised of two strips 21 and 22 respectively of hook and loop fastening material that are attached permanently to the surface 14. The fastening strips 21 and 22 cooperate with the fastening surfaces 17 and 19 of the outer surface 12 to permit device 10 to be selectively formed into and retain a potentially infinite number of closed loop configurations, as illustrated in FIG. 5. Once the waistband of a garment is fitted, then the fastening system and closed loop can be selectively released. Alternative systems for temporarily forming and retaining the device in a closed loop configuration as illustrated in FIG. 5 can be used on the inner surface 14 as previously described with respect to the outer surface 12.

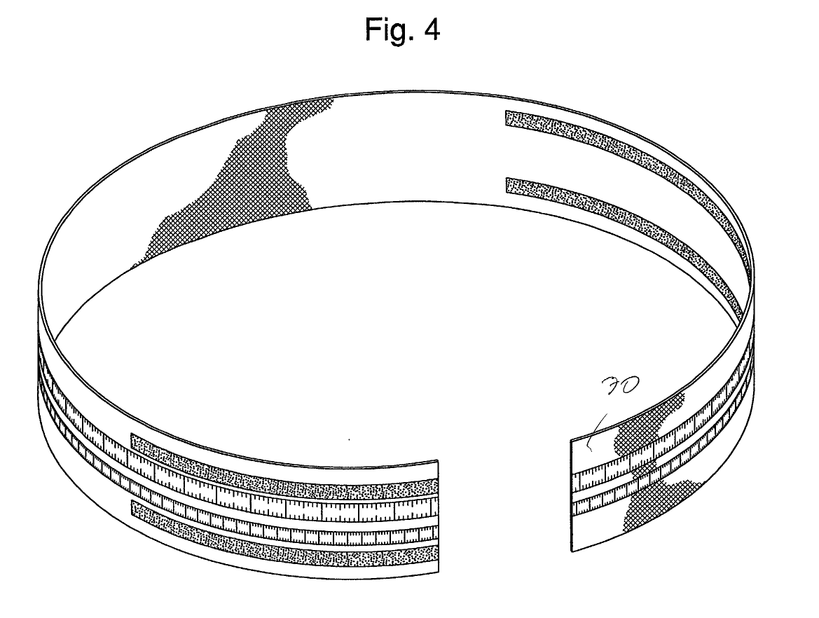

Use of the device to fit a waistband of a skirt will now be described with reference to FIGS. 1-2 and 4-5. To begin with, when using the device 10, the user would need to know through a separate measurement or information provided by the ultimate wearer of the piece of clothing to be fitted the waist size of the wearer. The waist size of the wearer can be replicated in a waistband using the device 10 with a great deal of precision (e.g., to the sixteenth of an inch or to the millimeter). Assuming that the wearer has a twenty-six inch waist, for example, the device 10 is formed into a closed loop as illustrated in FIGS. 4 or 5 by overlapping the leading end 30 of the device over the trailing end 32 until the leading end 30 terminates at the twenty-sixth inch measurement on the scale 16. The device 10 is then secured in a loop configuration by pressing the leading end 30 against the trailing end 32 until the respective fastening systems 15 and 20 engage one another to retain this configuration.

Once the device is in this configuration as illustrated in FIG. 5, the device precisely replicates a twenty-six inch (or other desired measurement) waistband without requiring the device to be fitted on the wearer or without requiring the wearer to try on the garment to be fitted in order to fit the waistband. The waistband 34 of the skirt 38 can then be fitted by pinning or otherwise removably securing it against the outer surface 12 of the device 10. By fitting the waistband this way, it is precisely fitted to the exact waist measurement of the wearer. The device 10 can be suspended by one or more hooks (not shown) that engage the bottom edge of the device 10 and allow the skirt to hang freely during the fitting of the waistband.

Once given the above disclosure, many other features, modifications and improvements will become apparent to the skilled artisan. Such other features, modifications and improvements are therefore considered to be part of this invention, scope of which is determined by the following claims.

I claim:

1. A device for fitting a waistband, comprising:
a flexible main body having an inner and outer surface, first and second ends and a measuring scale along a portion of its length, said main body being selectively movable from a first open position to a second closed loop position wherein said first end and said second end overlap and the size of the circumference of said loop is visible on said scale at the point at which said first end overlaps said scale;
adjustable means for releaseably retaining said body in a preselected second closed loop position that corresponds to a desired waistband size; and
means for releaseably attaching said waistband to said body located on said body below said measuring scale.

2. The device of claim 1, wherein said flexible main body has an edge between its inner and outer surface and said body stands completely on said edge when it is in a second closed loop position.

3. The device of claim 1, wherein said flexible main body has a void free surface.

4. The device of claim 1, wherein said means for releaseably retaining said body is infinitely adjustable.

5. The device of claim 1, further comprising a second measuring scale along the portion of the length of said flexible main body.

6. The device of claim 1, wherein said first end of said main body is flat.

7. The device of claim 1, wherein said first open position of said flexible main body is a flat position.

8. The device of claim 1, wherein said means for releaseably attaching said waistband further comprises a roughened surface.

9. The device of claim 8, wherein said roughened surface is made of burlap.

10. The device of claim 1, wherein said main body has a roughened outer surface.

11. The device of claim 1, wherein said flexible main body contains an inner member located within an outer liner.

12. The device of claim 11, wherein a portion of said outer liner is roughened.

13. The device of claim 1, wherein said means for releaseably retaining said body has two portions, said first portion being located on said inner surface of said body and said second portion being located on said outer surface of said body.

14. A method of fitting a waistband for an article of clothing for a wearer, comprising the steps of:
providing a flexible main body having an inner and outer surface, first and second ends and a measuring scale along a portion of its length;
overlapping said first and second ends to form a closed loop wherein the size of the circumference of said loop is visible on said scale at the point at which said first end overlaps said scale;
releaseably retaining said body in a preselected closed loop position that corresponds to a desired waistband size without trying on the main body on the ultimate wearer of the waistband; and
releaseably attaching a waistband to said body below said measuring scale.

15. The method of claim 14, further comprising removing said fitted waistband from said body.
